(19) United States
(12) Patent Application Publication
(10) Pub. No.: US 2009/0167843 A1
(43) Pub. Date: Jul. 2, 2009

(54) Two pass approach to three dimensional Reconstruction

(76) Inventors: Izzat Hekmat Izzat, Santa Clarita, CA (US); Dong-Qing Zhang, Burbank, CA (US); Mike Arthur Derrenberger, Valencia, CA (US)

Correspondence Address: Thomson Licensing LLC, P.O. Box 5312, Two Independence Way, PRINCETON, NJ, 08543-5312, US

(21) Appl. No.: 12/308,023

(22) PCT Filed: Jun. 8, 2006
(86) PCT No.: PCT/US2006/022215

§ 371 Date: Dec. 5, 2008

(51) Int. Cl. H04N 13/00; G06T 17/00

(52) U.S. Cl. 348/43; 345/420; 348/E13.002

(57) ABSTRACT

A method includes scanning a static background for background three dimensional information, scanning a dynamic foreground for foreground three dimensional information and combining the background and foreground three dimensional information to obtain a three dimensional model.

### FIELD OF THE INVENTION

The present invention generally relates to three dimensional modeling and more particularly to a two pass approach to three dimensional reconstruction of film sets.

### BACKGROUND OF THE INVENTION

There are a number of known techniques that either captures 3D information directly, as for example, using a laser range finder, or recover 3D information from one or multiple 2D images such as stereo techniques. These and other known single techniques do not perform well in all situations. Some techniques perform well only in indoor environments while others work in static scenes. Fully recovering the complete geometry of a scene in one pass is computationally expensive and unreliable. Three dimensional 3D acquisition techniques in general can be classified as active and passive approaches, single view and multi-view approaches or geometric and photometric methods.

Passive approaches acquire 3D geometry from images or videos taken under regular lighting conditions. 3D geometry is computed using the geometric or photometric features extracted from images and videos. Active approaches use special light sources, such as laser, structure light or infrared light. They compute the geometry based on the response of the objects and scenes to the special light projected onto the surface.

Single-view approaches recover 3D geometry using one image taken from a single camera viewpoint. Examples include photometric stereo and depth from defocus. Multi-view approaches recover 3D geometry from multiple images taken from multiple camera viewpoints, resulted from object motion, or with different light source positions. Stereo matching is an example of multi-view 3D recovery by matching the pixels in the left image and right images in the stereo pair to obtain the depth information of the pixels.

Geometric methods recover 3D geometry by detecting geometric features such as corners, lines or contours in single or multiple images. The spatial relationship among the extracted corners, lines or contours can be used to infer the 3D coordinates of the pixels in images. Photometric methods recover 3D geometry based on the shading or shadow of the image patches resulted from the orientation of the scene surface.

A solution is needed for recovering three dimensional geometries of objects and scenes that overcomes problems due to the movement of subjects, large depth discontinuity between foreground and background, and complicated lighting conditions.

### SUMMARY OF THE INVENTION

An inventive method includes scanning a static background for background three dimensional information, scanning a dynamic foreground for foreground three dimensional information and combining the background and foreground three dimensional information to obtain a three dimensional model.

In an alternative embodiment of the invention, a method includes acquiring three dimensional information of a static scene, acquiring three dimensional information of a dynamic scene, and combining the three dimensional information recovered for the static and dynamic scenes.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 shows three film set views obtained in a first phase in accordance with the present invention;

FIG. 2 shows a registration of the multiple views of FIG. 1 in accordance with the present invention;

FIG. 3 shows stereo algorithm steps in accordance with the present invention; and

FIG. 4 shows how the stereo algorithm of FIG. 3 is enhanced using the three dimensional 3D geometry obtained from the views of FIG. 1.

It should be understood that the drawings are for purposes of illustrating the concepts of the invention and are not necessarily the only possible configuration for illustrating the invention.

### DETAILED DESCRIPTION OF THE INVENTION

Unlike ideal conditions in a laboratory, in a real-world scene subjects could be in movement, lighting may be complicated, and depth range could be large. It is difficult for prior techniques to handle these real-world conditions. For instance, if there is a large depth discontinuity between the foreground and background objects, the search range of stereo matching has to be significantly increased, which could result in high computational cost, and more depth estimation errors. Therefore, it is desirable to treat foreground and background objects separately.

The invention is a two-pass technique for the recovery of three dimension 3D information. A first pass recovers a three dimension of a static scene using a low speed, high accuracy technique. Static scene scanning would need to be repeated multiple times to recover any new items introduced in the static scene. A second pass uses a high speed, less accurate technique to recover 3D information of dynamic scenes. The results of the two passes will be combined to obtain a complete three dimensional 3D model of the environments.

The invention deals with the problem of recovering 3D geometries of objects and scenes. Recovering the geometry of real-world scene is a challenging problem due to the movement of subjects, large depth discontinuity between foreground and background, and complicated lighting conditions. Fully recovering the complete geometry of a scene in one pass is computationally expensive and unreliable. Moreover, prior techniques for accurate 3D acquisition, such as laser scan, are unacceptable in many situations due to the presence of human subjects. The inventive two-pass approach provides more options to use those high accuracy reconstruction approaches, such as laser scan or structure light, to recover the geometry of the background.

The inventive two-pass approach recovers the geometry of the static background and dynamic foreground separately using different methods. Once the background geometry is acquired, it can be used as prior information to acquire the 3D geometry of moving subjects. It can reduce computational cost and increases reconstruction accuracy by restricting the computation within regions of interest. For instance, for the stereo-based methods for range image acquisition, stereo algorithms often need to search correspondence points in the left and right images. If the background geometry is available, the boundary of the foreground objects can be easily obtained. The boundaries then can be used to reduce the correspondence search range, resulting in less computation cost and higher accuracy of correspondence.

The inventive multi-pass 3D acquisition approach, as noted above, is motivated by the lack of a single method capable of capturing 3D information for large environments reliably. Some method works well indoors but not outdoor, others require a static scene. Also computation complexity and accuracy varies substantially between various methods. The inventive 3D reconstruction defines a framework for capturing 3D information that takes advantage of available techniques and their strengths to obtain the best 3D structure information. Combining multiple methods creates the need for new techniques to register the output of each method in a common coordinate system. The invention presents a simple manual technique to register the views obtained from each method.

The inventive multi-pass 3D acquisition framework will be discussed in the context of film set applications, but can be readily applied to other 3D reconstruction applications. In film set applications, 3D information is acquired in two basic scanning phases.

In a static scan phase, a high accuracy 3D acquisition approach is used to construct a three dimension 3D model of a static scene with no subjects present. In this static scan phase, a highly accurate possibly low speed method is used to acquire 3D data. Possible low speed scan methods include laser scanning or structure light methods. These methods produce highly accurate results in static environments without time constraints. Multiple viewpoints need to be acquired to construct a complete 3D reconstruction of the set.

In a dynamic scan phase, the dynamic acquisition of 3D information needs to be performed with a fast, possibly less accurate method of scanning. In this dynamic scan phase, it assumed that actors or other moving objects would also be present. This constrains the use of some method such as laser scanner because of safety or structure light patterns because it disrupts the film shooting. The most suitable method for this phase is stereo scanning since it satisfies the requirements above with no safety and distraction problems. The resulting stereo pair can also be used directly for real time broadcast. Although the use of stereo is emphasized in the dynamic scan phase because of the advantages above, other techniques such as photometric can be combined with stereo or replace it to improve the performance.

The results obtained in static scan phase can significantly improve the speed/accuracy of stereo matching. The speed improvement is achieved by only searching in an area with motion using the static model obtained in the static scan phase as a reference. The accuracy is improved by using the known 3D structure obtained in static scan phase to obtain more accurate point matching and possibly denser 3D data.

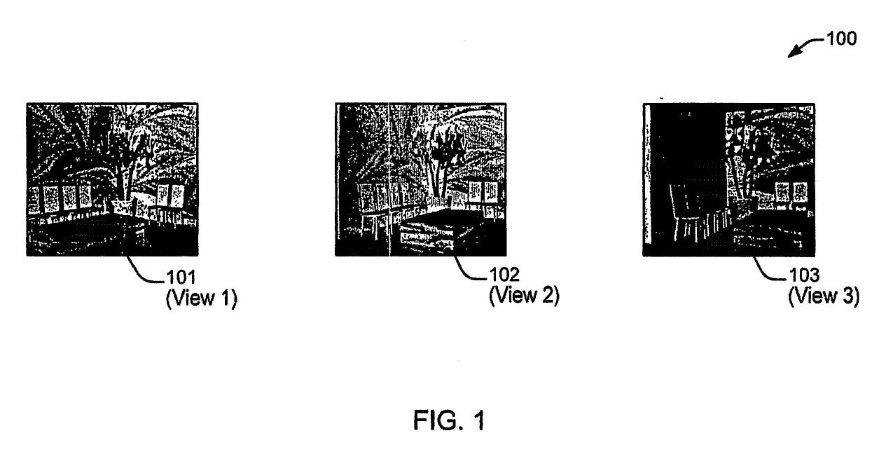

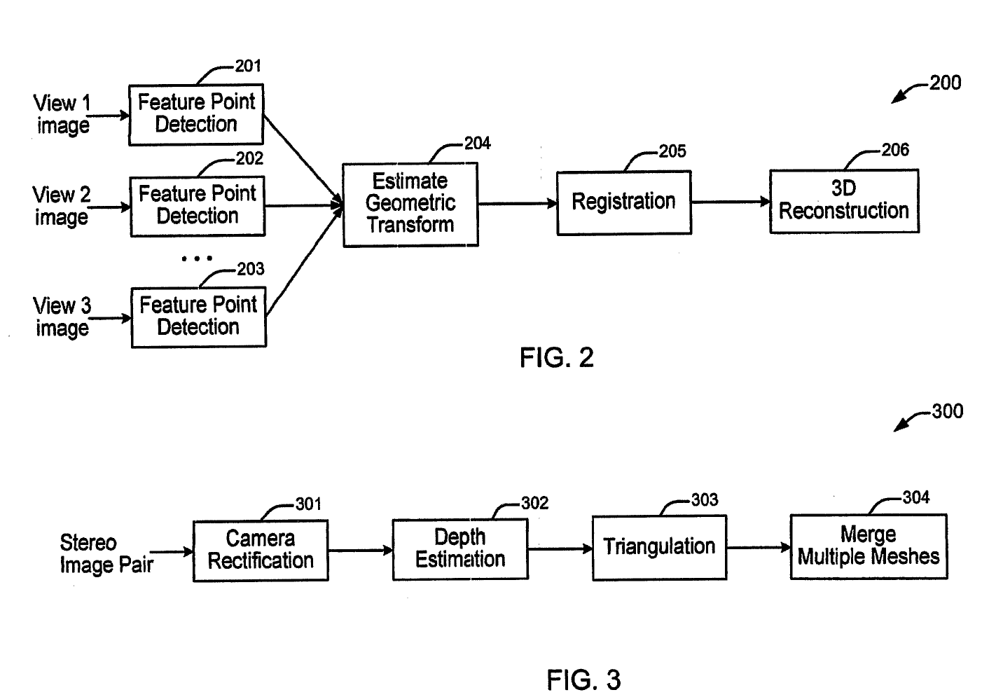

Referring now to the diagram 100 of FIG. 1, there is shown a simple film set from a number of viewpoints, view 1, view 2 and view 3, noted by reference numerals 101, 102, 103. The viewpoints 101, 102, 103 are combined in a common coordinate system to obtain a 3D model of the set. Referring to FIG. 2, a diagram 200 shows a possible method of combining the view 1 image 201, view 2 image 202 and view 3 image 203. The approach uses automatic registration with feature points or surface matching. Automatic techniques are usually not reliable and hence need to be followed by manual intervention. The most effective method would be to use an automatic method to obtain an initial estimate followed by a corrective phase, as needed, by human operator.

In FIG. 2 204, the parameters of the surface meshes under each view are computed. These parameters include edges, surface and relative translation and rotation between the surface meshes. The adjacency of the surface meshes is organized into a adjacency graph and passed to the automatic registration method in 205. The registration process aligns the surface meshes by, for example, error minimization techniques using the estimated parameters and the view adjacency graph. The error minimization technique moves or rotates one mesh with respect to other meshes to minimize an error measure. The registration algorithm can be significantly enhanced by providing the automatic algorithm information on the relative location of each viewpoint, for example, view 3 is to the left to view 2 as shown in FIG. 2. Once the views are registered with the registration algorithm, the resulting 3D model reconstruction 206 of the set can be viewed from various camera locations.

In the dynamic scan phase with actors and subjects performing, 3D information is obtained using stereo scanning. The results obtained in this dynamic scanning phase must be registered with low scan 3D model information results to obtain a complete 3D model view of the film set. The dynamic scanning phase can be done using a technique similar to that used in registering multiple views described above. In FIG. 3, a diagram 300 depicts the stereo algorithm steps according to the invention. A stereo image pair is subjected to multiple steps of processing. In block 301, a camera rectification is applied to calibrate the epipolar lines of the camera so that all epipolar lines become horizontal scanlines. Such procedure makes correspondence matching more accurate and efficient. Rectification is realized by taking a few of pictures of the calibration patterns in different orientations. Specialized software then is used to estimate the rectification parameters. In block 302, disparity estimation matches the pixels in the left image to those in the right images. The disparity is the distance between the matched pixels in the left and right images. Matching the pixels is realized by calculating the distance of the pixel features, and finding the corresponding pixels with minimum distance. In block 303, a triangulation procedure is used to convert the disparity values to the depth values. The triangulation procedure utilizes the camera parameters estimated in the camera rectification procedure and computes the depth value using a standard conversion formula. In block 304, the acquired geometry would be merged together to form a single mesh. The depth map 302 is obtained from the stereo image pair. The resulting depth map is converted to a 3D mesh 403 of the actual moving figure or person 404 and then integrated with the 3D model background view obtained from the static scan phase 401 for a complete view of the set.

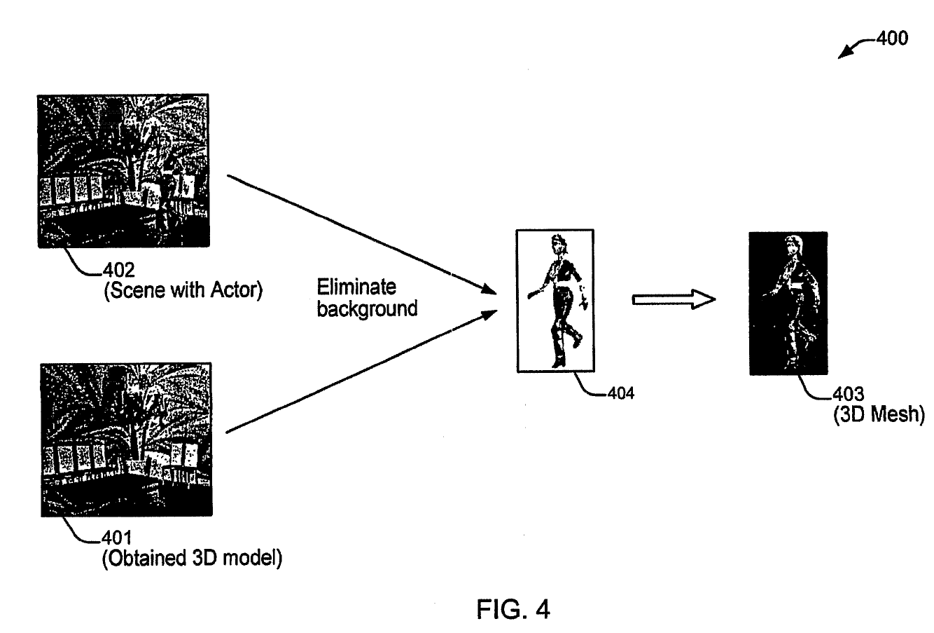

The diagram 400 in FIG. 4, shows how the stereo algorithm for the dynamic scan phase is enhanced using the three dimensional 3D geometry obtained from the static scan views of FIG. 1. Since we know the 3D geometry of the background from the static scan phase, the accuracy and speed of the stereo algorithm can be significantly improved. In FIG. 4, view 2 102 from FIG. 1 is used to enhance the dynamic scanning of a moving subject 404. The stereo matching is only performed in the area where new objects are present, in this case an actor 404. The 3D static scanned model 401 is used to eliminate the background information from the stereo scanned scene with the actor 402 and result in a 3D mesh model 403 of the actor. Enhancing the dynamic scan with the views from the static scan reduces the search area and hence increases the speed.

Having described preferred embodiment for the multi-pass approach to 3D acquisition in a film set application, it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method comprising the steps of:
scanning a static background for background three dimensional information;
scanning a dynamic foreground for foreground three dimensional information; and
combining the background and foreground three dimensional information.

2. The method of claim 1, wherein the step of scanning a static background comprises low speed scanning.

3. The method of claim 2, wherein the step of low speed scanning comprises one of laser scanning and structure light patterns.

4. The method of claim 1, wherein the step of scanning a dynamic foreground comprises high speed scanning.

5. The method of claim 4, wherein the step of high speed scanning comprises one of stereo scanning and photometrics.

6. The method of claim 1, wherein the step of scanning a static background is repeated responsive to changes in the static background.

7. The method of claim 1, wherein the step of scanning a dynamic foreground comprises subjecting a stereo image pair to depth estimation.

8. The method of claim 7, wherein the depth estimation of the stereo image pair is subjected to a triangulation.

9. The method of claim 1, wherein the step of scanning a dynamic foreground is responsive to the scanning a static background.

10. A method comprising:
acquiring three dimensional information of a static scene;
acquiring three dimensional information of a dynamic scene, and
combining the three dimensional information obtained for the static and dynamic scenes.

11. The method of claim 10, wherein the three dimensional information from the static scene is obtained using low speed scanning.

12. The method of claim 10, wherein the step of acquiring three dimensional information of a static scene is with one of laser scanning and light structure patterns.

13. The method of claim 10, wherein the three dimensional information from the dynamic scene is obtained using high speed scanning.

14. The method of claim 10, wherein the step of acquiring three dimensional information of a dynamic scene is with one of stereo scanning and photometrics.

15. The method of claim 10, further comprising repeating the step of acquiring three dimensional information of a static scene multiple times to acquire changes in the static scene.

16. The method of claim 10, wherein the step of acquiring three dimensional information of a dynamic scene is responsive to the acquiring three dimensional information of a static scene.
